(19) United States
(12) Patent Application Publication
(10) Pub. No.: US 2023/0108560 A1
(43) Pub. Date: Apr. 6, 2023

(54) Methods and Systems for Representation, Composition and Execution of Artificial Intelligence Centric Applications

(71) Applicant: CHANGFENG C WANG, Lexington, MA (US)

(72) Inventor: CHANGFENG C WANG, Lexington, MA (US)

(21) Appl. No.: 17/959,234

(22) Filed: Oct. 3, 2022

(30) Foreign Application Priority Data
Oct. 4, 2021 (US) 63251698

(51) Int. Cl. G06F 8/34; G06F 3/04817; G06F 16/901

(52) U.S. Cl. CPC G06F 8/34; G06F 3/04817; G06F 16/9024

(57) ABSTRACT

Artificial intelligence and data centric applications may be programmed, operated and managed systematically by using a common representation model of data, machine learning and other computing components and application logic and flows, and providing a configuration system with layered architecture involving computing nodes in a hybrid and multi-cloud environment involving computing notes of various architectures. Components can be easily added or changed to adapt to changing business requirements, and new layers of parallelization may be added to existing components. Thus embodiments of the method and system may play a role in artificial intelligence centric products akin to product assembly lines in manufacturing such as the auto industry, and with greater degree of granularity.

### CLAIM OF PRIORITY

This application claims priority to U.S. Provisional Patent Application Ser. No. 63/251,698, filed on Oct. 4, 2020 and entitled “Methods and Systems for Representation, Composition and Execution of Artificial Intelligence Centric Applications” the entire contents of which are hereby incorporated by reference.

### BACKGROUND

The convergence of progress in deep learning algorithms, advances in computing power including new architecture and speed, and the growth of data on the Internet is ushering in a new era Artificial intelligence (AI) technology. In the past decade, AI has helped bring about major breakthroughs in long standing challenges in scientific fields including computer vision, language processing, and biology. It is now poised to transform all aspects of business, science, and daily life in the coming decades.

AI transformations, however, can be realized only in the form of AI centric domain applications with some or all core processing logic driven by AI algorithms as live systems that interact with users or the environment. The focus of AI research and development has been on machine learning algorithms, including deep learning algorithms. How to develop, operate, and manage AI applications as a live system to meet organization objectives is not a well solved problem in AI research and the industry. Only recently has the topic become a research frontier in AI; and it has been challenging organizations that hope to participate in AI transformations.

Indeed, AI technology marked a paradigm shift in computing and how applications are developed: application logic is learned from data via machine learning algorithms rather than defined by human developers. Such is unfamiliar to most organizations.

Bulk of today's AI technology for applications building exists in the form of machine learning frameworks, such as Tensorflow and Pytorch. While these frameworks are at the center of AI centric applications, they represent only a small part of a much larger and highly complex technology stack for AI driven applications.

The foundation of AI applications is data. While today's machine learning algorithms are highly effective in extracting the information from data, they depend on human help in the entire process: find the right algorithms, identify and prepare and present the right data in the right form to build, operationalize, and manage applications.

Each application may involve a different and changing stack of components. Building up the application requires identifying and assembling the components, identifying and processing the right data, and composing and executing application logic, and deploying and operating in the right hardware computing environments. It involves complex processes of many steps and different tasks, and demands a premium on scarce technical skill sets with up-to-date and in depth knowledge of various stacks. Only very large and resourceful organizations can afford it. And those organizations that do have such teams and roles together are faced with the challenges of how to effectively collaborate.

Successful AI centric applications projects require collaboration between teams of various expertise such as domain experts, enterprise architects, data engineers, data scientists, software engineers, and devops, and IT operations. These roles need to work together to understand the domain, design the application, identify the data and use the technology stack to accomplish various tasks.

Organizations are challenged to come up with the required talents, and have the team work collaboratively in developing AI centric applications. Very few organizations can master the complexities involved and command necessary skilled resources and operationalize AI products. Indeed, according to Gartner, most organizations fail to progress from pilot project to production.

In addition, technology stacks and new algorithms and frameworks are emerging at a fast pace and evolving, requiring application developers to quickly keep up-to-date.

Currently, organizations follow an ad hoc approach in dealing with these challenges. AI applications are custom built by hiring teams of various roles to do design architecture, select technology stack including data, machine learning, and other components, and integrate the components individually. While automation in modeling training steps through autoML has made substantial progress, it helps only partly machine learning steps only, and the bigger challenge remains. One way to more reusable architecture is to fix applications frameworks for vertical industries with predefined data models and model driven architecture, but such approach is difficult to generalize, and difficult to adapt and reuse. Projects such as Kuberflow work mainly for machine learning steps also, and target highly technical users only.

These approaches demand high requirements of domain and technical skills, low productivity, and slow time to market. They also result in custom and fragile architecture that is not reusable and difficult to adapt to evolution of use cases, to adding new use cases, dealing with addition of new computing components, and changing underlying computing frameworks and computing IT architecture. Updating the underlying technology stack often implies redesign of business process logic, and increased operations cost.

Large cloud vendors offer products and services to elevate some of the pains by automating part of the process through hard coded engineering such as low code/no-code offering, but they apply to only fixed components and fail to offer a principled and systematic solution.

### SUMMARY

There is a need for methods and systems to help systematically build, operate, and manage AI centric applications, and address the complexity associated with technology stack. There is also a need for methods and systems to empower the larger community of business, domain experts, development, machine learning experts, enterprise architects, and IT operations, and enable them to contribute their skillset and collaborate on projects, with little additional training.

There is a need to leverage current cloud and computing architecture to enable high performance with computing components, and applications. There is further a need for adaptive and configurable architecture in anticipation of new use cases, routine addition of new algorithms and other computing components, and easy and quick response to change in underlying technology.

AI applications are data driven. It often involves large amounts and complex data of various types. Capturing, annotating, and processing the data in turn requires working with a large number of common and business domain specific computing components to discover, explore, analyze, transform, manage, transport, and govern the data resources. Examples include general purpose data processing stacks (such as image processing, language processing, statistical processing etc.), domain specific processing stacks (such as genomics, multi-omics, healthcare), as well as through for deployment, managing, monitoring models in various devices. Other examples include business domain specific engineered logics, sensors and other data producing components, domain process, and others.

Machine learning, especially deep learning, are both data and computing intensive, new algorithm frameworks typically are to explore computing architecture such as GPU, TPU, FPGA, and ASICS to help speedup training and inference computation. has developed a number of industry strength deep learning frameworks. Many other frameworks for data processing including R and analysis were not built to explore modern computing architecture, such as including distributed computing in the cloud environment and GPU/TPU, but there is a strong need to do so.

In general, one innovative one aspects of the advantages of this specification include systematic methods to build, operate, and manage AI centric applications as live systems. Any processing logic involving computing components, such as the machine learning framework Pytorch and data processing frameworks such as Spark, can be modularized by following a common model to become a reusable processor; any number of such processors can be assembled together following a common graph model to represent applications, with behavior fine controlled. The ability is similar to producing building objects using standard lego components; and the capability that the system affords to AI application building is akin to what the product line does in the auto industry.

Specifically, any computing component and data sources are represented universally using a processor model, which provides a modular and yet fine grained means to represent and invoke logic involving functions provided by the underlying components. The graph model consists of processors connected as directed graphs representing application programs, with behavior fine controlled by configuration parameters. Execution engines provide a runtime environment and orchestration graph execution process involving a variety of execution modes including batch, stream, and workflow, thus providing means to customize and optimize runtime performance. Together they provide a new and standard programming model and processing model for developing and operating AI applications involving a heterogeneous set of computing components and data sources. Such a model is particularly suitable for AI applications which are data driven. The model is expressive: it is Turing complete.

Aspect of the subject matter described in this specification can be embodied as a computing system (complete system) that can be configured, programmed, and operated for various domain application needs, and provide the complete technology stack constituting live AI applications in various computing and network environments, including standalone devices, public clouds, private clouds, on-premise, edge, or a mixture of them.

One advantage of the approach is simplicity that it brings to the AI applications development and usage lifecycle. Once a processor is in place, it may be reused and configured in many different applications and environments, and requires minimal skill and training to use. Another advantage is universality, because the same construction applies to any computing and data resources. The processor and graph can be understood and used for any domain, providing an effective language for teams of different skill sets to collaborate on the same project. A method for adapting resources to processors is part of the innovation, so adapting to changes in business needs and technology is a native feature of the approach. Other advantages will become clear in the ensuing description.

The system provides substrates that interact with other components from various sources. Thus the processor and graph provides a standard way to compose applications on top of customized technology stack. The components may include any development tools, machine learning library, data processing libraries and systems, domain specific application systems, packages, Web services, and others, to name just a few. Completed technology stack, including the hardware subsystems, are organized as layered architecture providing configuration points to manage the behavior.

The model also includes a standard way to describe and capture underlying data sources of any type and location to capture involved in the processing as metadata. In addition to serving as a means for automating execution logics of application graphs, the representation enables discovery and collaboration on data content.

More specifically, an AI application involves expressing the application as a graph comprising connected processors with connectors, and configurations that can be used to declaratively specify all aspect of the layered architecture: processor runtime behavior, input and output data, hardware architecture and storage, resource requirement of any granularity, thus providing a simple yet universal language to program and operate applications.

The programming comprising, select and add processors form a library, connecting the processors together, configuring the graphs. And processing comprises execution of the graph using various types of graph execution engines, whose constructs and operations also form part of the disclosure. Applications are executed as batch, streaming, a mixture of batch and stream processing, and other modes of data processing, as well as parallel and distributed processing controls.

Another innovative aspect of the approach includes a standard way to configure processor and graph, and using the specification to fine control application behavior at all levels along the architecture layers. These include component selection, component runtime parameters control, processing conditions, data input and output specification, computing resource usage and computing architecture selection (e.g. distributed, GPU/CPU). In addition to supporting dynamic component deployment in a cloud agnostic way, it provides standard ways to configure and optimize computing, resource usage, and application runtime performance. Change and addition of computing components and addition of new use cases is part of the native built in feature that the system allows.

Together they provide a standard programming and processing model that is capable of universal representation of any processing components and allows composing the components as applications, and executing the applications in a production environment. The modularity and simplicity enables users of various roles to interact with the computing system in a uniform way, and importantly, a simple and yet expressive common language standard way for all the roles to effectively collaborate with each other.

Yet another innovative aspect of the subject matter include graphical and programmatic user interfaces that provide standard ways to compose applications, operate, and manage applications from anywhere. Sitting on top of the programming and processing model, and through a distributed architecture, makes it simple and easy to collaboratively develop, operate, and manage applications using the same user interface. The graphical user interface provides a drag-and-drop for visually composing application pipelines, and for configuraging, testing, executing, and monitoring applications, and sharing with others using Web browser through a remote client device. Embodiment of the system and methods thus enabling the entire team to perform their own tasks, publish and share their work, all using intuitive interfaces requiring much less training. The unified model together with the graphical user interface allows low-code and/or no-code programming, The reduced skill set allows a much larger community of users to participate in the process (democratizing AI).

Yet another innovative aspect of the subject matter is a method and system to execute the application processors and graphs. In addition to allowing the graph to be executed using different engines and modes, it provides means for conditional execution, and for adding parallel and distributed processing capability to the application and underlying components.

Another innovative aspect of the subject matter methods for common data communication and sharing between any components to satisfy various performance needs of those components. A standard means of data content object model encaptures the data resources of all types and sources, allowing all computing processors and underlying components common means to access and operate on the underlying data, and communicate input and output of processing, and work with storage media of all types, share data in memory, network, or storage classes.

Yet another innovative aspect of the subject matter included methods to enable high performance computation through parallel and distributed processing of existing components in various comp. One aspect of the parallelization is dedicated processors associate with computing components to support various hardware computing architectures for parallel and distributed processing, such as Pytorch and Tensorflow in deep learning with GPU/TPU and distributed processors; another aspect including using the graph representation and special processors such as MapReduce to add component level parallelization, enabling parallel and distributed processing of existing components to leverage the computing and data architecture, providing data, task, and pipeline parallelization for processing using underlining components. Thus adding another layer of performance boost in addition to parallelization and component level.

One other aspect of the innovation includes methods to automatically track and record lineage of all the data used in the processing, providing fresh data for reproducibility, downstream process communication, quick debugging, and governance.

Other innovative aspects of the subject matter include methods for deployment of the computing components in a computing substrate independent manner, providing a consistent user and application development in public clouds, hybrid clouds, on-primes, edge, and other environments.

In one example embodiment, the computing system and methods can be deployed on the cloud, on-premises, or a mixture. One set of computing nodes with GPU and high performance CPS, may be formed as clusters to host data attentive computing components such as GPUs and CPUs for computing component runtime for data and machine learning processing; another set may form a cluster to support host graph executing engine and processor executors runtime. Development and operations teams can use web browsers on user end devices including desktop/laptop and mobile devices to interact with the programming and orchestration nodes. End users or applications may interact with modeling servicing runtime nodes on devices outside of the computing system including mobile phones, desktops, and servers in a different cloud.

Yet another example embodiment may replace part of the model runtime nodes by edge devices, and thus allowing the runtime model to run on edge devices while modeling and other data and computing intensive operations running in the cloud.

The foregoing summary is illustrative only and is not intended to be in any way limiting. In addition to the illustrative aspects, embodiments, and features described above, further aspects, embodiments, and features will become apparent by reference to the following drawings and the detailed description.

These and other aspects, features, and various combinations may be expressed as methods, apparatus, systems, means for performing functions, program products, etc.

Other features and advantages will be apparent from the drawing, ensuing description and the claims.

### DESCRIPTION OF DRAWINGS

FIG. 1 is a block diagram of computing system and environment

FIG. 1A illustrates the distributed architecture on cloud and on-premises

FIG. 1B describes an edge embodiments cloud and edge cloud

FIG. 2. Application representation graph model

FIG. 3 is a block diagram of graph flow representation and composition design

FIG. 3A is a block diagram of nested composition design

FIG. 4. describes the graph dataset and usage

FIG. 4A is the graph dataSet model

FIG. 5 is a block diagram of processor, driver API design, and components

FIG. 6 illustrates the graphical user Interface and visual programming design

FIG. 6A is the graph programming/composition process

FIG. 6B describes the user interface communication

FIG. 7 is a block diagram of graph execution engine

FIG. 8 illustrate the graph execution and orchestration process

FIG. 8A is the processor execution processing flow

FIG. 9 describes Architecture layers and configurations

### DETAILED DESCRIPTION

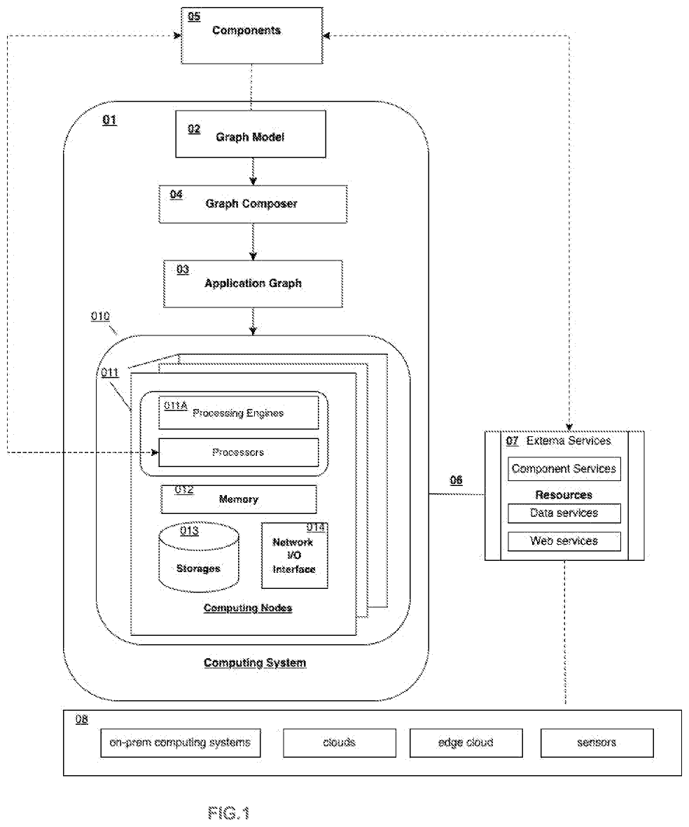

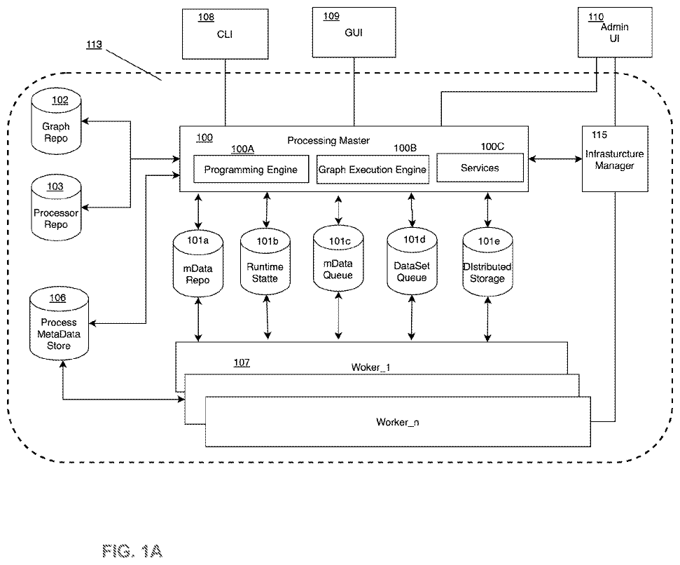

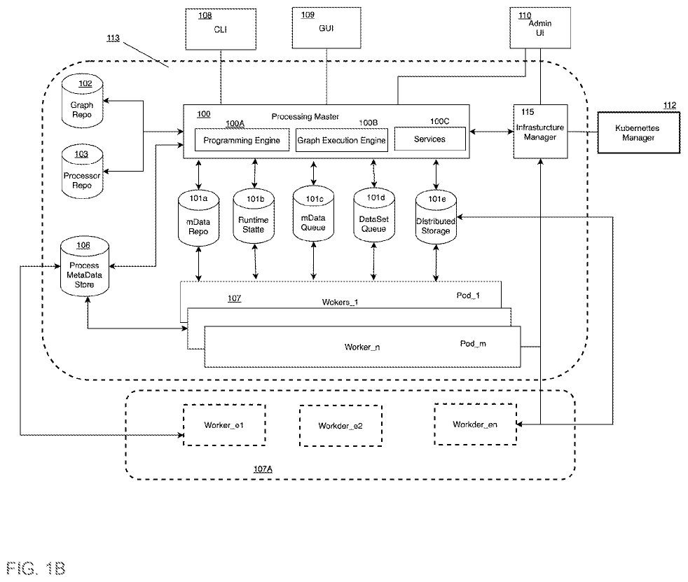

Referring to FIG. 1, a computing system 01 and the environment to represent, build, and execute artificial intelligent centric applications involving components 05 from heterogeneous sources including libraries or external services running in network connected environments. The computing environment 08 may include desktops, on-premise computing and data centers, public clouds, edge clouds including mobile phones, smart devices, sensors, and other networked devices.

Advantages of the platform include a systematic way to turn any components into modular building blocks called processors, and graph based models to represent, program, manage, deploy, and execute the application in a cloud agnostic manner, solving major challenges and leading to multitude of benefits. The specification moves from the prior arts of focusing on an individual subsystem of data and machine learning processing to an application perspective that views the entire cloud as an operating system, and various existing components as subprograms or libraries, and explore all layers of cloud (including edge cloud) computing architecture for efficient application building and execution.

It provides and environment and systematic methods to solve the critical problems of how to modularize various components, how to assemble the modules together with a graph-based model, how to efficiently communicate data and commands between modules, how to program applications that require minimal skill set requirements (e.g. drag-and-drop) and no/low coding, and orchestrate execution where enabling new layers of parallel and distributed processing. In addition, the platform provides a built-in solution that solves a new problem that arises from AI centric applications, that of reproducibility and trust.

The system is designed from the ground up to encode domain knowledge and use the knowledge to drive programming and execution, helping solve a major bottleneck in AI applications development associated with the paradigm shift from the traditional human logic specification to data-driven logic extraction with machine learning algorithms. The gap between domain experts and application developers is identified as one of the major challenges in AI adoption, with techstack complexity being another.

The system includes a concept of processor library, which keeps track of existing components of various versions and exposes the components from different perspectives. For example, by functional perspective with algorithm view, it hides the complexity of implementation details, thus allowing models who have little knowledge in software development to use the processors.

The design allows dynamically to create techstack for custom applications from a library of modules, solving the complexity of techstack problems. With applications being encoded as graphs that are declaration text stored in the repository, along with turning components to modules, it solves a critical problem of how to move from experiment to production. Any experimental modules after plugged in as a processor, it becomes part of the platform, can be used in programming with a drag and drop user interface, communciat data with other processors while leveraging the speedup in parallelization and distributed processing provided by the platform.

The system includes a new execution engine that executes and operates the processing flow across component boundaries in a distributed environment. It keeps the state of execution as well as events, and supports both batch and streaming processing. Together with the graph model, it forms a powerful new computing system capable of processing data of various granularities. The platform includes a concept of graph DataSet (referred to as DataSet), which provides a unified interface for data content of all types, solves an unsolved problem and enabling unified and efficient data communication both through all types of persistent and in-memory media on the networks, and transparent transformations and conversions. These advantages are explained in more detail in the remaining part of the specification.

The system graph model and execution engines enable lineage tracking and retrieval, and lead to the solution of a new problem associated with AI application, the reproducibility and trust. Furthermore, configuration and tracking data enables methods to automate computing resource allocation and optimization.

Putting together, the tech advantages translate to business benefits include solving the techstack complexity, knowledge gaps in business domain to development, talent gap, experiment to production, resulting in better efficiency and less cost in building and operating applications with less knowledge, and helping solve new problems of reproducibility in AI systems.

Modern AI centric applications are data driven and involve machine learning and complex data processing systems and varieties of software packages for managing, ingesting, transforming, and processing of large volumes of data of all types and formats. They also require exploration of storage, data communication, and leverages distributed and parallel computing architectures. In this specification, all types of software for processing, including libraries, algorithm frameworks, and services that might implement these components are abstracted as the term component 5 in FIG. 1. Some examples include libraries in various computing languages for data ingestion, machine learning algorithms frameworks such as Tensorflow, Pytorch, as well as various computer vision and language Web services in the public clouds for classification, object detection, language processing, translation, text analysis, and others. Examples of systems include Apache nifi, Apache Spark, R, and Hadoop to name just a few.

Applications can be represented using a graph model 02 as application graph 03 which represents component 05 as processors that are stored in a processor library 011B. The application can be programmed using programming module graph composer 04, which produces and stores the graph representation. A processing engine retrieve the representation and translate it into executable code and then executed using the computing system node clusters 010, which may comprise a set of computing nodes 011, each running one or more processing engines that host components 05 locally, or on one or more of separate nodes in the computing system, or further translates the processing code into commands and executes the command on a different environment such as through Web services in the cloud, edge clouds as remote services in 07. The computing nodes 011 may be virtual machines, physical devices such as servers, desktop or other computing devices, as well as docker containers or pods of Kubernetes cluster.

The execution elements may include different types of execution engines and services that creates and manages the graphs, store and retrieve the application graphs, and implements and execute the graphs using the components that execute the The computing nodes may comprise storage device 013, memory 012, and processing units such as CPU, GPU/fGPA, ASICS and others. The storage device 013 and memory 012 may be physically attached to the computing nodes, or in a detached but accessible computer network.

A graph model 02 provides constructs and a simple language involving a few elements for unified representation and interface to component 05 or and remote resources 07 which may be service that implement component 05, datasets of various types, such as images, text, structured data, and unstructured data that are accessible as databases systems, file systems, memory, or networked storage devices; The resource 7 may also be any Web services accessible through an endpoint.

The components 05 may be a general software library including a data processing system such as Apache Spark, Apache Nifi, or a machine learning system such as Tensorflow, Pytorch, and others and any functions that work on data. It may also be Web servings that implement these components or other application services that may take data as input and respond with data items. Examples of such applications services 6 include public cloud services for data processing systems such as Spark and Machine Learning frameworks such as Tensorflow.

Part or all of the components may be included as part of the computing system 01. In this specification, we use the words computing system and computing system interchangeably to refer to 01.

Such resources may be in the form of frameworks and exist as software packages, or exist as a running service such as AWS lambda function, a Web services, or others that are running in the cloud, edge devices addressed using Internet protocols such as URI and reachable by the computing system with a service endpoint.

FIG. 1B shows a distributed embodiment of the system. FIG. 1A Shows another embodiment of the platform that is with a container management system and also may involve edge cloud. More details are explained later in this specification.

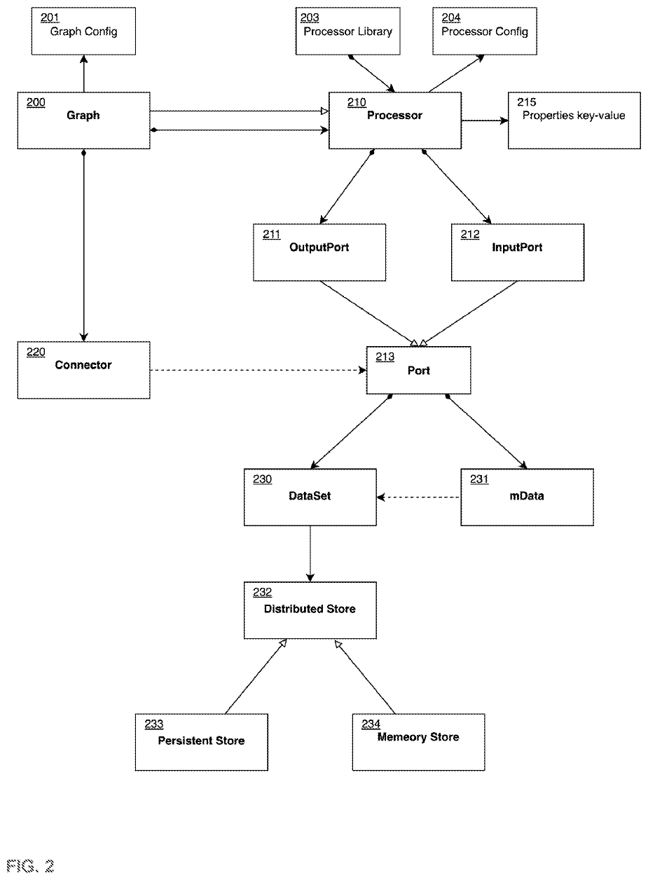

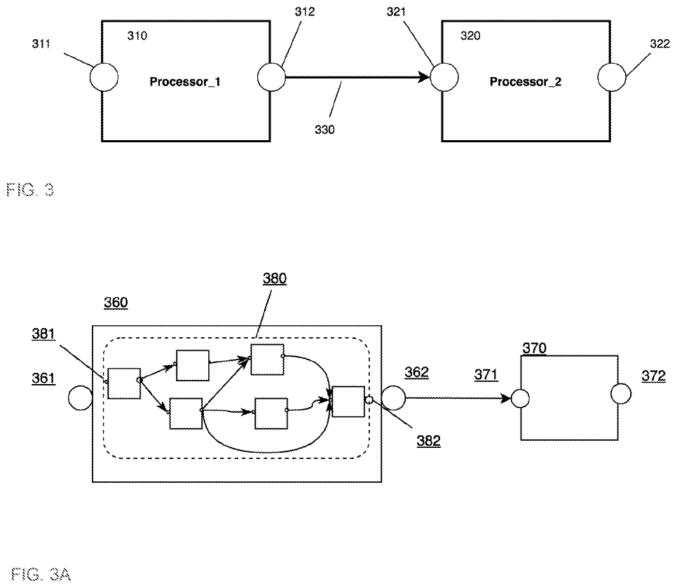

Referring to FIG. 2, an application may be represented as a graph 200 with configuration 201. A graph comprises a set of processors 210, which constitute nodes of the graph, and connectors 220, which constitute edges of the graph. Each element in the graph has a new set of properties so as to completely represent an application. A processor represents a computing unit of components 05 in FIG. 1. More than one processor may refer to the same component 05 by implementing different aspects of the functiona; and one processing may refer to multiple components to represent one function.

Graph provides a global namespace for all processors. It also holds a set of processors from a processor library 204, and that are configured with configuration parameters 204 for specific runtime processor instances. The connector represents a direction and sequence (priority) of processing, while processors and connectors allow definition of processing logic and fine details of data and workflow logic.

Each processor 210 has a unique identifier, a name, and a processor instant name that may be defined by the user when creating a processor instance in composing the graph. Processors may have a set of properties in the form of key-value pairs 215. These can be used to hold values for defining the unique processor properties or dynamically add runtime configuration unique to the specific component that the processor encapturates. Processor 210 also has a set of configuration parameters that can be used to define user specified configurations at programming time or execution time, defining different implementations of the same function, or any other configurable properties of the processor. The parameters are used to instantiate the processors to create processor instance objects.

Each processor has at least two ports, one input port 211 and one output port 212, unless it's a root processor or leaf processor on the graph, in which case it may have an output port and one input port only, respectively. Each port is assigned an identifier uniquely within a single processor. For example, it can be identified by a numeric number, and a type indicating input or output or others. Each port also has a unique identifier across processors, which may be composed combining the processor identifier and the port number.

Processor contains at least two or more ports, at least one InPort and at least one OutPort that provides a mechanism to specify input and output data to the processor. Optionally, the processor may also contain log and error ports for loggins and error data specifications.

Port 213 provides a unified way for processors to transport and exchange data that it processes. Each processor has one or more InPorts and OutPorts for data io with other processors as well as data sources (origin and sinks).

The graph model allows processors to plug together processing logic as well as dataflow, thus making it possible to have a simple programming model that involves only a few elements of programming. In addition, the graph mode lets application logic be represented independent of a detailed implementation component being used, providing a live documentation of business logic that is long living, with components that can be swapped out without affecting the logic. It's a goal that some prior technology frameworks such as model driven architecture and associated tools tried to achieve in general application building, but failed short. The specified model solves the problem. Along with configurations, it enables a declaration based programming model that lends to drag-and-drop visual programming described later, removing much of the architecturing requirement and lowering skill set required for stitching complex system components together to ones require very little programming skills, allowing wider audience, especially domain expert to participate while increasing productivity.

Graph provides a scope for shared resources and services for efficient data and messages communication between the processors, including access to runtime DataSet, mData, commands, and any events that need to be accessed in a distributed environment.

Data resources of various sources, granularity, location, distribution, format, may be described mData 231. mData provides a standard way to capture metadata of content information of data and machine learning model resources. Referring to FIG. 2B, each mData includes a unique identifier, name, description, location of the data specified in the URI protocol format. It may also include detailed content descriptions using a content schema, which may be in the form of json, xml, yaml or other format, included as part of the mData or reside in a network accessible location specified by the URI protocol or equivalent. It may also include ownership, version, creation date/timestamp, as well as classification of the mData. In addition, it may include information and content classification and other information to facilitate search and discovery of the data, as well as information for connection to resources, authorization and authentication.

The mData, by describing the resources, informs processors and logic components of the content information, putting together, it encodes documents the business knowledge context in concrete terms, help solving a problem in difficulty in understanding business domain context. It then informs in designing application logic in the programming steps, and allows metadata drive processing in execution, simplifying both programming and execution steps. When mData are linked together through graph processing later, it automatically becomes a lineage graph of data and models, helping documenting processing, while at the same time, serves as a key elements that makes the application reproducible, a major new problem in AI centric applications the industry and research community is in the process of trying to address.

Content of Data resources of various sources, granularity, location, distribution, format, may be represented, addressed, and operated on uniformly using Graph DataSet (GDS) 230, which provides a unified interface and methods for transparently connecting to, reading, writing, and transformation, and other operations involving the underlying data.

DataSet provides a common distributed payload for data communications between all processors. A DataSet service may be provided to interact with DataSets. Processor receives data as one or more DataSet objects from the input ports, and creates one or more DataSet to represent data that it stores in storage media (e.g. via pvc in Kubernetes) or memory (via shared memory).

A major problem is having a heterogeneous component as part of the system is data communications between them. In related systems such as Kubeflow, it is so far an unsolved problem. Graph DataSet adds a new construct that solves the problem of efficient data communication with zero-copy, and provides a simple syntax to use, while allowing conversion and transformation extensions to allow more detailed transformation work with various content types and processing functions.

At the system level, connectors help implement a layered architecture component that hides the physical connection to resources (DataSet that is described by mData). It does so by associating an mData 231 and DataSet 220 from the inputPort, and propagating it to the outputPort. Specific propagation behavior is defined by the graph processing engines and executors that are described later.

All static information about a processor can be captured and stored in a processor database. The processor database may further be linked to a processor library 203 on FIG. 2, and used by programming module 04 on FIG. 1.

DataSet 230 that goes through ports are specified by mData (meta-Data) 231, and each port may have zero or more mData objects, and may implement CRUD methods (e.g. reading and writing). Each port also has zero or more DataSet objects. Specific numbers are dependent on the processors.

During execution time, each processor may receive mData and DataSet from its inputPorts, and perform actions and create new DataSet and mData, and associate with the it's output ports.

To pass data and interprocessor communication information, both input port 211 and out port 212 may be associated with a set of properties captured by port 213, which can be implemented in many different ways such as as an interface or new class in object oriented language, as an interface.

Connector 220 is an edge on the graph that connects two ports. It logically represents a workflow and data flow direction at data processing level, and represents an execution order sequence (upstream and downstream) in the execution workflow.

Each graph has at least one processor and zero connectoros. So that a single processor is also a graph. A graph may also be a type of processor. Thus, a subgraph can be wrapped as a processor is a graph. This allows compositing graphs from other graphs, and mathematically allowing composition of functions. To enable sub-graphing, graph may implement processor interface, with input ports being that of the root processor or other selected process, and output ports being the output of leaf processor of the graph. For example, in task two task parallel graphs graph 1 and 2 takes input x as DataSet, and create y1=F1(x), and y2=F2(x), respectively, and graph 3 takes y1 and y3 and produces output DataSet z=G(y1, y2), then a new graph may be combined with sub-graphing to create function z 32 G(F1(x), F2(x)).

Referring to FIG. 3, a data-driven application can be described using workflow using a graph model. Each Graph is represented as a directed acyclic graph (DAG), with a set of nodes and edges. Nodes of the graph are referred to as processors 310 and 320, and edges as connectors 330. Each processor has at least two ports, one input port (311 and 321 for processors 310 and 320 respectively), and one output port (312 and 322 for processors 310 and 320, respectively).

Referring to FIG. 3A, nested graph composition can be nested. A graph 370 nested as a subgraph by exposing it as a processor 360. Input ports of root processors graph 380 are mapped to input ports of processor 360, configuration parameters of graph 380 mapped to that of processor 360, and output ports of leaf processors are mapped to the output of processor 360.

Composition of the graph is composed by connecting one or more processors of one graph to the input of another graph. New graphs can be composed from existing graphs in two ways: Linear composition and nested composition. Nested graphs play a similar role as objects in object oriented programming, helping to hide information and better construct more complex building blocks. Example usage scenarios of nested graphs include compositing new applications out of team members of one or more different groups or the same group; another usage scenario is scoping in which nesting is used to hide unnecessary details.

Using a graph model to represent data-driven application logic is common and widely used in computer science. Combining a graph model with modular and configurable processors and connectors supporting inter-processor data communication in a distributed environment allows representation and specification of sophisticated flow based programing logic.

A set of operations may be associated with the graph and the associated elements to compose, configure, and execute applications, as well as manage the artifacts. Specific operations are described in the following.

To help compose an application using the graph model, create, read, update, delete, and save (CRUDS) operations may be defined to create, read, update, delete on computing devices and from memory or media on graph, processor, and connectors.

For each graph, the CRUD operations may be associated with the unique identifier, or name of the graph when the name is unique. A graph is further associated with CRUD to and remove processor and connectors, and add, remove, and update configurations. For each processor, CRUD operations are used to add, remove, and mark the mutability of ports, and for updating the associated attributes, such as mData and mData URI or other location identifiers.

Similarly CRUD operations may also be defined on mData. In addition to CRUD, operations may be defined to manage mData and graph processors to help to facilitate retrieval and management of mData, graphs, and processors from respective repositories, as well as for importing and exporting these artifacts.

Processing time operations may be associated with graphs, and processors. These may include required operations to run the main commands with associated arguments, and operations for changing, updating, retrieving the runtime state, as well as setting time intervals for polling the state, and call back operations.

These added operations together with the static elements of the processor provide a standard and modular interface and construct to represent and execute heterogeneous components of various granularity levels as coherent computing units for configuration based programming. Additional constructs that using the processor interface enables representation and execution of various processing capabilities, including distributed and processing of AI and big data applications in a multi-cloud environment, supporting batch, streaming, as well as Web service programming models, and while adding new layers of performance optimization for all components. With the model, the platform provides an environment that provides tools and systematic ways to translate AI centric applications building and operations to traditional software and data engineering that enterprises are familiar with.

For those who are in the profession of software development, it is common knowledge to define the above operations in REST API, and different implementations of the operations can r be code generated for various programming languages for both client and servers side, such as Python/Java/Go and JavaScript and TypeScript for Angular.

Both client and server side APIs can be created for the REST API. Client and Server code in various languages can be generated from the API. And services and user interface applications created by implementing the APIs.

As an example of processor representation, the processor interface corresponding to the operations (in python pseudo code, only some elements are highlighted) on the server side may contains a set of standard methods including main operaon to call the invoke operations on the components, state control, pre-process, and post process, error handling, and other custom, state control functions.

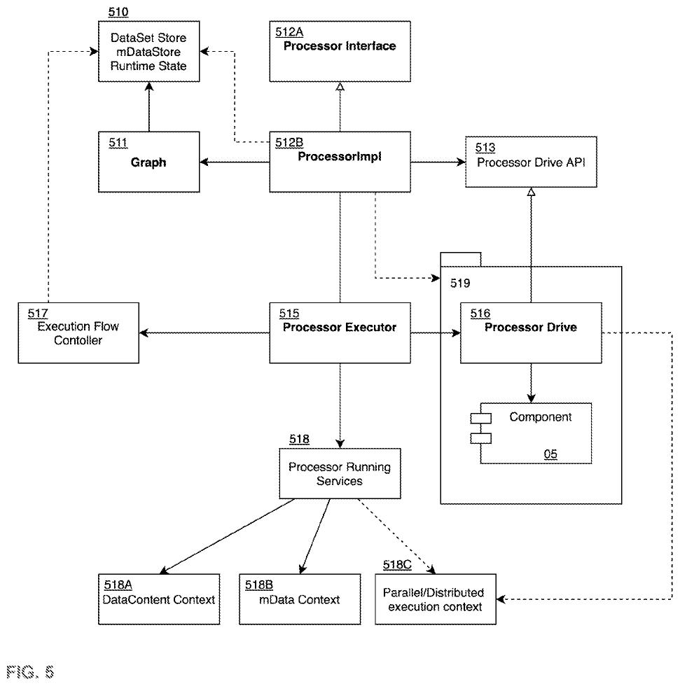

Each processor must implement the main method method serve (*arg, **args), which when called, results in execution of the underlying components. How the underlying component is called is defined by a standard model described processor design in FIG. 5. State dictates the current state of the processor in the life cycle, and error indicates an error state. Poll sets a time interval for the state of the processor to be reported.

Concrete names of methods are outlined only to help explain the ideas. For those who have ordinary skills in the trade, it should be clear that the functions can be named in many other ways, and an equivalent set of the functions and attributes can be defined to accomplish the same purpose. In particular, the call of the serve( ) method will cause invocation of the main function, which may be a function call of a library or command to a remote service.

FIG. 5 describes a method to systematically create processors to represent the underlying components. Once the processor representation is built, it can be included as part of the processor library and to build applications with the graph programming model and executed in the runtime environment.

All processors in Processor 210 on FIG. 2 that represent a version of component 5 on FIG. 1 have a common Processor Interface 512A. A processor implementation ProcessorImpl 512B implements the required functions as defined by the processor. Each component 05 may be represented by one or more processors, and each processor may be implemented on top of multiple different implementations of the same functionality.

Processor Interface 512A provides a standard interface for all processors. This interface included the attributes and operations (methods) described earlier, and standardized interaction with component 5. It enables reference to the underlying components in programming the application as a processor, and in execution of the component as part of the application during runtime. For those who have ordinary skills in the trade, it should be apparent the model can be implemented in any modern programming languages such as python, java, and others.

Referring to FIG. 5, a processor implementation ProcessorImpl 512B implements the main method will cause execution of the component. It may also include functions to manage and control, and report the state of the component execution where it applies.

Invocation of the main method causes operations on the input data and mDatam and translates the output of the component to DataSet and makes the data available at it's output ports. The Processorlmpl may use a standard processor executor 515 to standardize execution and cause execution of the component in different ways. For example, the executor may use a set of data processing services and context, including DataSet Context 518A for data operations and mData Context 518B for mData access and operations. This context may be simple access through graph object 511 to distributed stores 510 (as shown in the embodiment late in the description). The executor may also provide a mechanism to launch the component in a distributed environment such as Kubernetes pod with parallel and distributed services.

The Processor uses DataSet and mData information from the input ports to receive DataSet and mData information. In addition it may pass information to a component as part of the command line argument derived from or as configuration parameters of the processor to communicate such information. A standard Processor Driver API 513 may be defined to abstract out the command and data input and output communication and translation between the Processor port and component.

For those who are in the trade it should be clear there are many ways to define the Drive API to wrap library functions and services. For example the API may mirror the Processor API attributes and functions described earlier. The advantage of a separate Drive API is decoupling, so that developers of the processor drive 519 do not need to have knowledge of the Processor API details. Depending on the type of component, for example, whether it's a library or remote service, the Processorlmpl may be implemented in many different ways. For example, if component 5 is a regular library form, Processorlmpl may just implement the Processor API without explicit executor. The Processor Drive 516 may use a distributed engine to manage the distributed processing of the component 5.

In a container embodiment in particular, processor drive 519 comprises a docker image that has different components as libraries such as Tensorflow, Pytorch driver functions that use the framework. Processor invocation would then involve deploying the image to the container and running commands on the container through a container platform such as Docker or container orchestration Kubernetes.

Processor is a key to allow modular composition of applications and unified execution, medata data driven processing that simplifies graph composition and execution, and allows recording of lineage information in processing and enables reproducible applications that will be discussed later.

In addition to modularity, it hides unnecessary technology complexities in using components from end users who access it as processors, and through one time processor drive development, removes a major knowledge gap and allows more users of less programming skill set to use the components.

Processors may be hosted in a processor library and stored in a database or other media. Each processor in the library will have a unique identifier, identifier of the processor, name, description, version, creator, and create date and time data.

It may also contain category information and Tag information that are based on a standard taxonomy to classify the processors into different categories, and developer and user defined tags. It may contain other information identifying the processor source, source location (urI).

Taxonomy associated with the categories and tags to help organize the library. Taxonomies may further be linked to documentation of the processors and underlining components and other information and made available to the in graphical user interface with different actions such as highlight, right click of mouse, etc.

Example of Taxonomy may include categories such as Data Processing, Languages, Machine Learning, Deep Learning, Stream Processing, Computer Vision, Nature Language Processing, Web Services; the categories may further include different algorithms, algorithm families, categorization such as supervise, unsupervised, Semi-supervised, and under Deep Learning different neural network architectures.

A set of basic processors may be provided, for example:
1. Base processors: Processors for basic system commands and interacting with the environments
2. DataSet and mData Processors: dot production on keys-value, cross product, Copy, Combine, MapReduce. Inclusion of these and similar operations afford the system different theoretical expression capabilities, for example Turing completeness.
3. Data ingestion, data transformation component and systems, such as Apache Nifi, Dask, Spark, and others
4. Processors to run machine learning algorithm framework for hardware architectures
5. Processors for AutoML, feature store, and annotation
6. etc.

For some applications, it may also be desirable to introduce processors that allow feedback loops from output to input, one such example is to encode state transition without relying on the state keeping mechanism. Global state access through graphs or introduction of feedback looks are two independent features that make the graph computing Turing complete.

Static processor information that is used to build a Processor information can be stored in the database.

Organizing processors as a library has many advantages and helps solve some major problems in AI centric application development, especially when drag-and-drop visual programming environments as described in the following are used. While processors make component integration modular and remove much complexities in using it, organizing the processor as a library removes knowledge gaps in using components by putting them at the fingertips of users. In machine learning for example, algorithms and neural network architecture, once developed, remain stable and change only slowly. The same algorithms are implemented in many different frameworks, expose them as processors abstract out the framework implementation details, and let the user focus on the function it plays in building applications.

FIG. 1A shows an embodiment of the platform in FIG. 1 in a distributed environment. A processing master 100 comprises a set of processing engines and services. Primary processing engines include programming engines that graph and manage the processing through user interactions. Another engine is the graph processing runtime engine 100B that executes the graphs, as well as a set of services that provide functionality for supporting these processes. Examples of the services include database management services for creating, reading, updating, and deleting (CRUD) various storage objects for each repository 102, 103, 106, and 101a, 101b, through 101e. It may also include a host of services that are necessary that would be familiar with those in building Web services based applications when the system is deployed as a Web service with REST API.

The processing engines and services may be associated with storage media 102 for storing application graphs, and 103 for storing processor libraries for application graph programming. And storage repository 106 for storing runtime processing metadata required for reproducibility, system health, and debugging. It also may include a shared storage 106 and memory for distributed access, these include shared memory, storage classes that are accessible through networks and reachable through network connection. These storage devices provide the media for storage as well as media channels for data communications between processors. The system also provides shared storage for storing graph execution states, including graph runtime states, processor state, availability data content, and mData on processor ports, state of the storage media and memory during distributed processing, It also provide storage for DataSet 101c and mData 101d that are communicated during runtime.

The programming engine and execution engine may run in the same processing nodes or different processing units. The graph processing engines and services may be distributed so that execution orchestration is run on a set of master unit 100, and the underlying component that the processor represents runs on a set of workers.

The programming engine and execution engines can be accessed through a common REST API, and have a command line interface, as well as graphic interface that support visual programming, execution control, and management.

The system may include infrastructure management user interface 110 and services 115 that manages that and monitors and reports the system runtime status and health. This information may further be imported as part of the medata store, along with execution runtime. The infrastructure management services 119 may use services and tools that are associated with the deployment infrastructure.

In one embodiment, as is shown in FIG. 1B, the platform is deployed on Kubernetes clusters. The master and workers are Kubernetes pods. These pods may be running on nodes that are on-premises, private cloud, and public cloud or a combination of them.

The programming and runtime engines may run on the same or different pods and virtual or computing nodes. Part or all of the workers may also be running on pod groups 107 on servers in the cloud, and another set on edge devices in edge cloud 107A, including mobile phones, smart medical devices, or other devices that are network accessible. The worker pods may be managed by the infrastructure manager, and the status may be managed by the graph execution components, components that are run in other workers, or the infrastructure manager during the deployment process and runtime process, or a combination of them. Runtime repositories are made accessible to all the platform workers 107 and 107A as well as the graph execution master.

There are many possible variations of this embodiment. For examples, a variation of the embodiment may have part or all of the repositories and storage running as services in a different cluster, either Kubernetes or other computing environment, and have some workers run in the Kubernetes environment to leverage Kubernetes pod as a way to distribute workload.

In another embodiment, the master, the workers can all be deployed on a single computing node. This might be useful for development and debugging purposes, although it may be of limited power in production.

In yet another embodiment, the master and workers can be deployed on physical hardware servers, and accessed through user interfaces on desktops or mobile devices. These physical hardware may be running in on-premise, private cloud, or public cloud, or a combination of them. In yet another embodiment, these physical nodes can be replaced by virtual nodes.

Applications may be composed by creating a graph and configurations. The graph may be stored in a database or other media. An execution engine can be built to translate the graph to executable code and execute in a computing environment. In one embodiment of the graph model, a web service architecture may be used and a REST API implementing the operations on graphs and processors can be used to help implement the programming and execution operations.

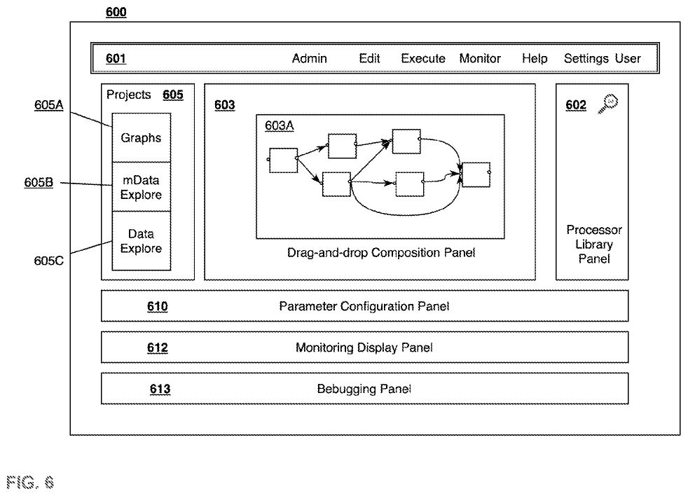

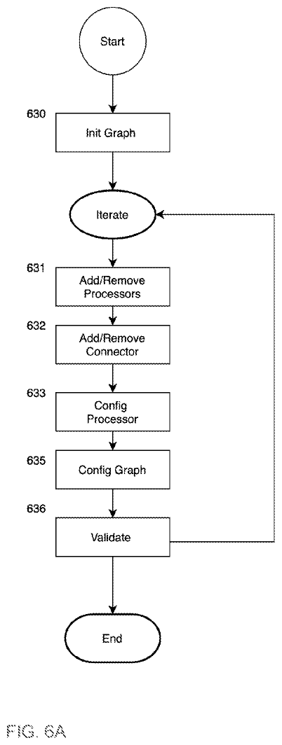

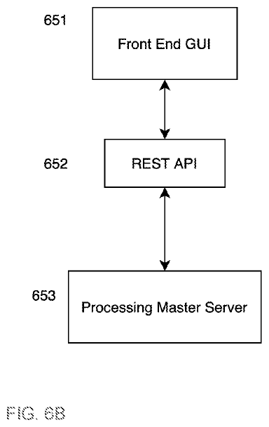

Referring to FIG. 6A, using an embodiment of the system to create applications generally involves the the following processing steps:
1. Create graph structure by iterating on the following step:
   a. Add/remove processors
      i. Add ports (automatic)
      ii. Add/remove connector
   b. Config processor (driver/image, runtime options, xd specification, mapping, opt_args in each architecture layer)
   c. Validate edit time configuration
2. Config graph runtime parameters missing)
3. Validate configurations
4. Save/Update/remove graph to repository

Referring It is understood programming is an iterative process. Order of steps may be omitted, repeated, or switched by the user as situations arise. The above process can be performed through either command line interface with various programming languages that interact with the REST API interface.

Referring to FIG. 6, a visual interface system 600 may be built to interact with the platform. The Interface will act as a client to the platform, and perform various aspects of actions such as programming applications graphs, managing the graphs, and executing and monitoring the application life cycles. A primary means of interaction with the platform will be through the REST API. Some actions such as those involving administration jobs may also communicate the rest of the system by directly working with the runtime environment by connecting to the processing master through other channels such as operating systems interface, and through third party tools for system infrastructure management such as Kubernetes and network management tools.

Processors in the library may be accessed visually by providing a panel 602 that displays the processors, such as folder structures based on taxonomies of library organization, tags that are added by the developers of the systems or by the users. It may further include a search and filtering functions that help to limit the processors.

The interface may further provide panel 603 for composing the application graphs visually. Referring to 603A an application is visually represented as a connected graph, with the edges representing connectors in the graph model. Composition of the application involves visually carrying out the procedure in the programming steps Programming Procedure 6A. Adding a processor involves selecting a processor from the right processor panel 602, and adding to the 603, Specific actions may be configured depending on the display device, such as mobile device or Desktop device. It's common knowledge to those who are in the trade of building graphic interfaces that there are a wide variety of ways to create the visual effect. Each processor icon may be further configured to include a name, instance name, and other attributes that are described in FIG. 2 and associated specification texts.

Complete graph information as described in the graph model earlier in this disclosure may be specified visually, for example the topological connection between ports, name and description of the processors and processor instances, and other artifacts, processor configuration information, mData association, data mapping between ports, and others. In the visual composition process, the client invokes appreciated REST API calls to the new and updated information in repository 102.

A panel 601 may be included for taking actions, including graph editing, execution, and monitoring and analysis, platform administration, settings, user and account connections, and others. Edit may further include actions to read, save, delete, and validation of the graphs. The panel 601 and 603 may further include other actions, such as visual changes that only display information without changing the graph definition. Part of all of these items can be added. It may also be advisable to have one interface for programming and testing, and another only include actions for execution time.

The panels can be combined, rearranged, and reorganized, and many visual artifacts may change. In all cases, the graph and processor representation allows the simplified visual programming and execution of the processes.

The interface 600 may further include panels 610 filling out detailed processor and graph configuration parameters, these could include filling forms on the panel, as well as uploading files from client devices. It may include a debugging panel 612 for showing detailed validation information during editing, and execution error stacks information for error and logging content for during execution graph execution content, in addition to the regular system stack trace that infrastructure management tools such as Kubernetes might include.

The interface may further include a project panel for organizing graphs 605A, exploring mData 606B, data resources 605C, model content, and other resources.

When a Web client is used to render the interface, the panels may be implemented as a Single Page App in one embodiment. In another embodiment, the content may be implemented as separate interfaces for different user roles, for example, one for editing and execution, another for execution only, and yet another for administration of the resources, or various combinations of them. The content of panels may also be implemented on mobile app devices, displaying the same content of the panels, but organized differently by fitting it to more user actions on the devices.

In a Web client, in particular, the programming process described in FIG. 6 can be carried out by a drag-and-drop process. Referring to FIG. 6B, the processor library is loaded to the frontend in FIG. 6A through an REST API call to the processing engine backend and displayed to the user. User follows steps described in FIG. 6A to create a graph. The user searches and find the process from the library, and drops on canvas, which results in adding one processor to the graph, which is saved to the backend graph database automatically as part of the graph model; the user repeats the processor by adding more processors. Two processors are connected by linking the ports and configuring ports by selecting the right numbers on each end, and configuration. As illustration, the following visual processing may be involved in greeting a graph:
1. Pick up select processors from processor library
2. Configure processors, including name, ports, mData, specify drivers, driver parameters, optional arguments
3. Connect ports:
4. Config ports/connectors: specifier port numbers on both ends, specify mdata, data mapping, specify buffers communication buffers
5. Configure graph
6. Run validation (all required parameters are present)
7. Publish graph

As users go through the process, results are saved to the back end graph database through API calls. Similarly, the same API can be used, and a programming language such as python, java, javascript, and others in lieu of visual programming can be used to write programs. Client side SDK can be created by wrapping the the processing engine API. It can then be used to talk to the backend by importing the SDK to program and execute graphs.

Each processor includes one or more input or output ports (zero or more in the case of origin and sink), which are used to define 1) connection topology when in both workflow and dataflow specification; and associated mData and and DataSet in case of dataflow.

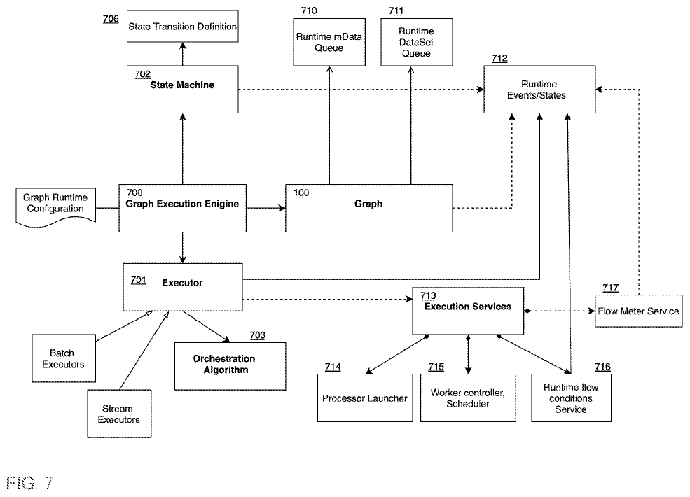

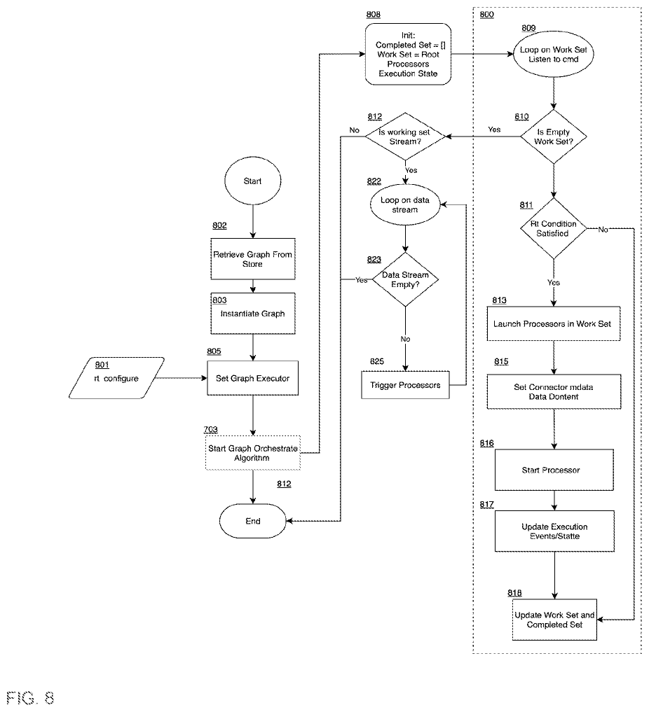

Referring to FIG. 7, a graph execution engine can be built to execute application graphs. The execution engine provides context and key functions to manage graph runtime life cycles, orchestrate the processing steps, and provide the parallel and distributed processing capabilities. An execution engine 700 provides context for distributed graph execution: Name space, environment variables, and common services. The execution engine uses a common Executor 701 to execute graphs. Graph is retrieved from graph repository and graph instant is Instantiate and passed to the execution engine to execute, along with runtime configuration parameters. The execution engine may associate an executor 701 to execute the graph instance. The execution 701 uses an orchestration algorithm 703 to traverse the graphs, and may employ a set of execution services 713 to control the execution process. These services may include processor launcher 714 helps to create and control processor runtime environments. This may include launching or pod groups, and then starting the processor. One embodiment of the launcher is the Argo workflow engine.

In one embodiment, the orchestration algorithm 703 is used to first translate the graph into Kubeflow Pipelines, and use Kubeflow KFP which may employ an Argo workflow engine to launch and execute the components represented by the processors. The process may further be combined with a worker controller that controls the node lifecycle and/or scheduler 715. At runtime, each graph install is associated with a distributed runtime mData queue 710 and DataSet queue 711 to communicate mData and DataSet objects between ports.

The execution engine may use a state machine 702 to keep state and control graha and processor runtime lifecycle/state (start, pause, suspend, debug, stop, etc.). The state changes may be made available as a service either push or pull to graphs and processors to help processing. In addition to the state changes, the state may also include metering and usage of resources, such as data communication channel capacity through flow meter service 717, DataSet media capacity, cpu/gpu usage, and media store usage levels, memory usage. This information may further serve as input to Runtime condition services 716, which, combined with an orchestration algorithm, controls the execution process. In the case of stream processing, the services may be made available to processors which in turn use the information as a control parameter to automatically trigger execution.

A common orchestration algorithm 703 may be used to orcherate the processing flow both of batch and stream processing for all executors to control logic flow sequencing as workflow defined by the topography of the port to port connection, and also of processing orchestrate data flow and information between processors. The algorithm provides a natural way to perform processor level (component) and pipeline parallelize and distributed processing. Different variations of the executor may be implemented by extending the executor, in combination with other and data flow engines, such as Airflow, and Kubeflow, Dask and others.

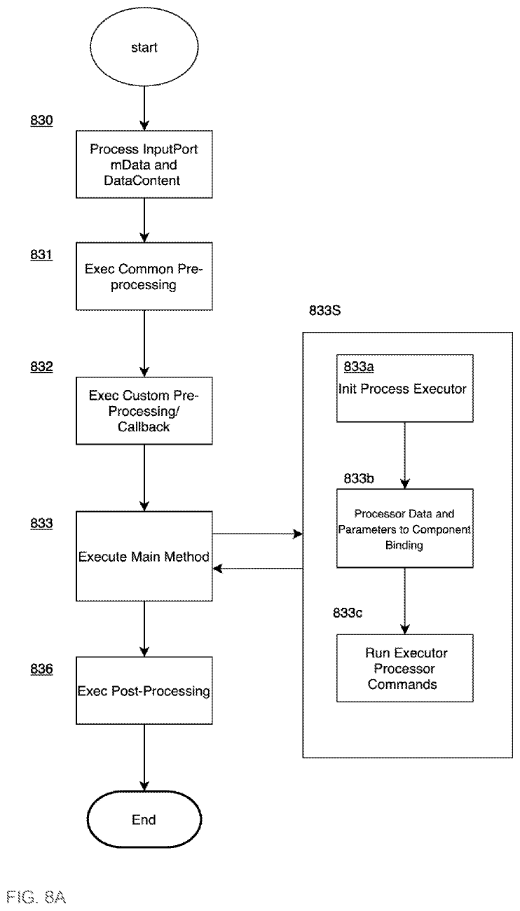

FIG. 8 Describes the general process flow of the graph processing. It's easy for those who are in the trade to see there may be many variations of the implementation. Different types of executors can be used to execute processor commands in various modes to meet processing goals, including batch or streaming processing, different ways of parallelization and distributed processing. In one scenario, the executor runs batch processing. In yet another scenario, the executor runs for streaming processing. Data communications are taken care of by the DataSet object scheme. In yet another, batch and streaming processing may be mixed in one graph. DataSet object provides a unified communication mechanism between all the processors on the cloud, in yet another scenario, part or all of the processing could be running on edge devices.

Kubernetes container management and Jobs may be used together with DataSet object to parallelize and distribute processors on different nodes and pod groups may be implemented as Kubernetes jobs to manage container distribution as pod groups; it can also be implemented Customer Resource Definition extensions. For batch, graph can be translated to workflow, and executed using a workflow engine such as Airflow or Kubeflow (Argo Workflow Engine)

After a graph is retrieved for storage, a graph object is created to create a graph instance that forms a job to be executed by the executor. Runtime configuration parameter 801 is applied to further configure the graph, and for controlling various aspects of execution behavior. The executor executes the graph by running the algorithm 703 starts the main processing algorithm 703 and enters the execution loop. Depending on if the processor subset in the working set is for stream or batch 812, different processing loops are run. Both loops involve running the orchestration algorithm constituting 808 and steps in 800. For batch processing, the main graph topology is scanned once, starting from the root nodes with the algorithm.

The algorithm starts by initializing and keeping a working set of processors and a completed processor set. The loop also listens to the command from the execution engine for state change commands. Whether a process launched or executed may be defined by both the priority defined by the graph topology and runtime conditions check result 811. The runtime condition may further be a function of state state of mData and DataSet from the upstream processing, user set conditions from rt_configuration; it may further be a function of the capacity of the data communication channels and computing resources capacity level made available by execution services for resource optimization and metering.

The orchestration process involves launching the processors in sequence, setting up the port connections, setting mData and DataSet links, and may also involve running processor pre-processing and post-processing for processing lineage recording. In step 815, after the streaming pipeline is set up, the processing listens to incoming data and will trigger execution when new data is received; In the batch model, the processor execution is triggered once on the incoming data, and then moves to the next working set and updates the working set 817.

Different processor launchers may be used, depending on the mode in launching step 813 to control where and how the processors will be launched, number of replications, resource usage, parallelization and distribution, scheduling, and other aspects of runtime behavior.

Thus there are different layers of parallel and distributed processing supported: At graph level, component and pipeline parallelization, and at processor level, different parallel distributed support related to underlying comps, such as distributed processing with Spark and GPU architecture and distributed CPU processing with pytorch and tensorflow. General distributed processing context such as Ray and mpi can be plugged to enable additional capabilities.

For streaming, the orchestrate algorithm is run once to set up the pipeline and then enters loops on incoming data streams. While the data stream lasts, each processor's main processing method is triggered to process the data. Triggering may condition the content flowing metering based on the data flow speed and resource capacity information made available by the runtime state services.

In implementation, Both loops 809 and 822 may also include listening to execution engine commands to listen to state changes from the user. A processor launcher may start a processor in the same process as the orchestration, start one or more threads, one or more sub-processes, or start one or more pods or multiple processing nodes. After the processor is launched, the processor may run the process as described in FIG. 8A. Data and mData from input ports are gathered and processed, along with optional arguments from the execution engine in step 830 for subsequent processing. A basic set of pre-processing function 831 that may include creating lineage related data comprising recording of the mData identifiers, mDataSet, and DataSet key-value information.

A custom pre-preprocessing and callback 832 may be executed if it's implemented by the processor. The main processor method is called in step 833. Specific may may be a simple library function call and returns after the processing completes. In more complex cases, it involves invoking the processor executor processing and entering steps in 833S, in which an processor executor is used in step 833a is initiate, and processor level parameters, optional arguments for runtime configuration, and data at processor level are mapped in step 833b to component recognizable values, and submitted to the component to process 833c. For example, a long running process for large distributed jobs in machine learning and Spark jobs that talk to Spark clusters may involve this mode. The execution may result in it may also enter a service mode, and listen and respond to various client calls including state uptaing, poll configuration, in addition to processing the man functions. For stream processing, for example, the main may enter into a loop mode and process a new DataSet as it arrives.

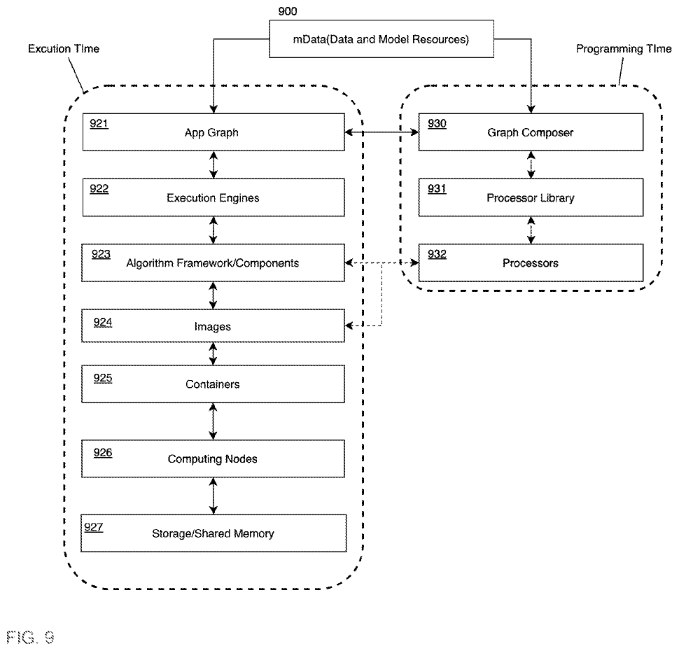

Referring to FIG. 9, the architecture layers of the computing system and connection between various processes in embodiment 1 and 2. mData service 900 is used by graph composer 930 as well as the runtime layers. During programming time, mData and processor library information are queried to compose the graph, and runtime layers are partially invoked for validation, during which processors are instantiated but are not launched for execution. The information completed defines a graph job. During execution time, each of the architecture layers may be configured by setting runtime configuration parameters, further defining the behavior of the execution process.

Configuration can be done at editing time during graph composition, and before execution. All graph elements can be configured, A configuration file specifies how a graph is run to meet requirements when executed as application pram. These include customization for at application level involving input data in terms mData, processor level specifications, system architecture, resource usage, and others.

Processor configuration specifies the processor name, backend components including algorithms in terms of drivers, runtime arguments, resource usage, media storage, memory, component level parallelization configuration such as number of workers, parallelization schemes and others.

Graph level configuration controls the input source to the graph and how and when execution is run. Involve initial input data in terms of mData, sink, resource access information, graph level resources allocation including computing, storage, and networking, executor selection, which graph parallelization and distribution.

Editing time and runtime configuration use the same mechanism. Configuration consists of specifying a set of parameters that control behavior for each architecture layers in FIG. 9
1. Processor constructor and runtime parameters (specific to Processors)
2. mData and DataSet for each ports
3. Execution engine
   a. Conditional execution (optional)
   b. Mode of execution
4. Algorithm framework selection
5. Computing architecture selections
6. Resource usage(memory and number of cpus/gpus)

Editing time and runtime configuration use the same mechanism. Configuration consists of specifying a set of parameters that control behavior for each architecture layers in FIG. 9

Standard Configuration Syntax All levels of configuration may follow the same syntax that can be specified in a json, yaml, xml format or equivalently as command line arguments. There are many ways to specify the configuration. For example, in json format the following pattern can be nested to configure all elements:

{“element_type”: {“optional_param_key”: “optional_param_val”}

With element type being graph, connector, processor, executor, user defined selections, runtime, and others. Furthermore elements may be grouped, and additional layers property may be added. Those who are in the trade should see clearly how this can be extended and also translated to different encoding formats, including XML, YAML, etc. There are also tools to automate the translation.

Graph optional parameters control the behavior of graph processing and different architectural layers and stages of processing steps. These parameters are passed to graph processing through the runtime configuration parameters in the UI to the execution engine. The configuration accepts JSON files. It may include graph level configuration identified by key as “graph”, executor selection by “executor”, realtime processing by the key “rt”, etc. Each key may be accompanied by a description key, and each key may further contain a new level of association map to specify keys for that group.

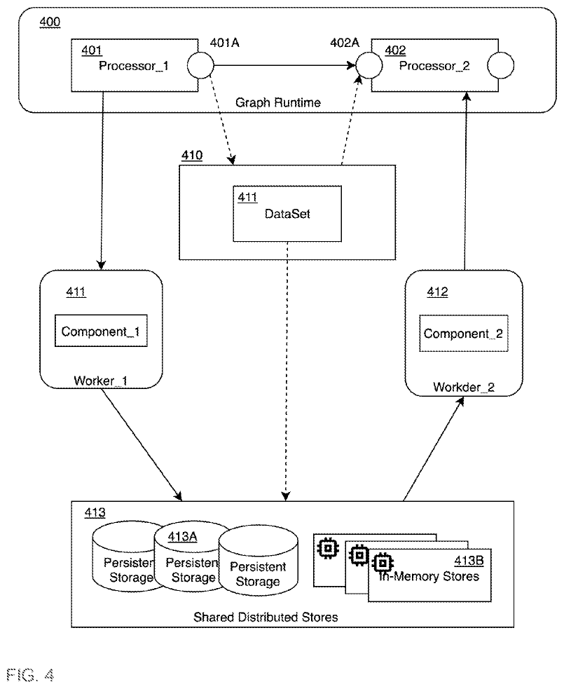

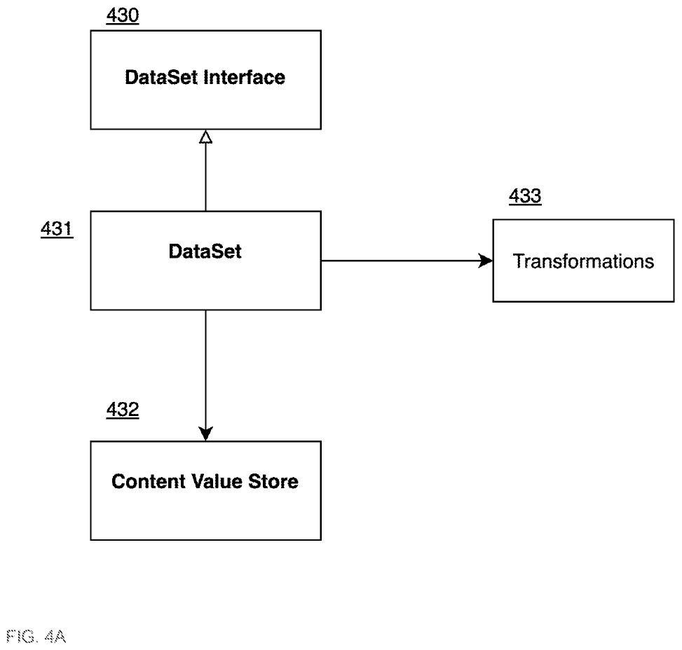

Referring to FIG. 4 All data payloads flowing from processors 401 to 402 may be represented and operated upon using DataSet and related services. It provides a standard mechanism for reading, writing, and operating on the data values for all processors. In addition to unified access in programming syntax, the DataSet object enables zero-copy data communication between processors, and enables data access acceleration integration that may involve network, persistent store, and shared memory. The operation may also provide transparent format changes and data encoding coding, thus simplifying data mapping operations.

Referring to FIG. 4A, DataSet model, DataSet Interface 431 provides a common interface for addressing and operating on underlying data of all types and locations. Data represented as key-value pairs, with keys assigned by the client of DataSet or added automatically. For example, in Python, a DataSet can have a dictionary as an interface for addressing the content. So that data with foo and value bar may be read as ds[foo], and set as ds[foo]=bar, with ds being an object of DataSet. At the base level, it provides a read/write method for reading and writing with key-value. It may also provide iterators to traverse through the content values and discover keys associated with the value. Data value can be data objects, forms, types, such as a file or set of files in various file systems in various formats, a record in a database, a column in a database table, or a single element in the relational database, or it may directly map to a data in a key-value store, to name just a few.

Each DataSet is associated with one or more storage media for storing the actual value of the data. DataSet addresses the value by key. Since data value can come in various formats, DataSet may provide a standard method to transform into various types. For example, if the value is a file, it may provide a method convert_to method or equivalent that converts between various formats. It may also provide a standard interface to plugin functions for operations on the key-value pairs and data values, such as MapReduce, copy, and others. It may also provide transformation method 433 that work on the specific value types in various frameworks and languages. For example, sql operations transformation if the store is a RDBMS database, and RDD or DataFrame operations if working with Spark, and Pytorch Dataset operations in the Pytorch framework. In each case operations may translate to execution of functions in the storage media, or through functions in graph runtime space, or different runtime environments.

Referring to FIG. 4 Data values may reside anywhere addressable over the networks. The DataSet uses key-value pairs to associate the values of data in the store. Each DataSet object 411 may be associated with one or more storage media 413, which may be any persistent storages 413A such as disks, cloud storage, file systems, and others, or memory stores 413B. Implementation of the read/write interface provides transparent CRUD operations on the storage media.

In the execution processing, graph runtime environment 400 may maintain the DataSet queue using a distributed in-memory store 410 accessible to all processors. In one embodiment, the in-memory store 410 and 413B may be separate stores, in another embodiment, they may also overlap and share the same physical storage.

As an illustration of how a DataSet Object is used to transport data on FIG. 4, Procesor (Proessor_1) 401 may produce a DataSet object, which has a key pointing to a large blob of in-memory data (e.g. Spark RDD as a value), key and value is stored in the shared memory store 411. The next processor 402 takes the object from the memory store 410 and does further processing in the same memory space. In another scenario, the value 401 produced may be a large file stored on persistent data, and the processing carried out by Component Compoen_1 residing on a worker 411. The value in this case is a reference to the file, and processor 402 may pass the reference to Component 412 which accesses the file. It should be clear that there are many possible scenarios depending on the execution environments and type of underlying components and storage media and type of values.

In programming the processor may use only mData which describe the resources, including schema and content location. The executor propagates the mData from the output port of the upstream processor to the input port of the downstream processor. In the most basic format, graph executors can add the mData from the upstream port to the input port of the downstream processor. Alternatively, the downstream processor can also fetch the information by following the connection topology in the graph. The mData schema field and other information can then be used to automatically set all or part of the downstream processing in programming and execution time. Specific usage may depend on individual processors. Different processors may use the mData to further automate mapping to internal logics,

mData allows composition of processing flow, and thus more complete configuration of the graph without looking at the actual data sources. This isolates the pramming from execution, allowing isolated development and operations separation, a critical requirement for enterprises and moving from experiment to production. For development, automated processing also simplifies programming, leading to more efficiency and productivity.

The result of graph processing will create persistent data and models. The goal is to be able to keep track of the lineage and reproduce these artifacts when needed. These are done through mData, graph, and associated processing. How this is achieved is described in the following.

All persistent data and models generated as a result are described by mData, which provides a generic mechanism to record metadata information about data and models. In particular, each mData has an id, allowing with indication of whether the data is model and data.

New mData is produced by Processors (in addition to mData created by users) for DataSet produced by the processor. There are different levels of metadata information that mData encodes, for example at data entity or DataSet (e.g., field and record in structured data, or k, value in key-val paris) level. Content level association is possible only if the Processor creates such information during processing.

Some important new problems that arise from AI applications are reproducibility and trust. Both relate to and centered on how and what data are used in producing a new model or dataset. How the problems can be solved when processing involves components from heterogeneou sources is wide open. The problem is naturally solved and customizable with the graph processing system in this specification. Some of the key advantage of the method is that it is inherit to the system, and varieties of relationships can be defined, and can be integrated using existing various tools for metadata analysis, graph analysis, and inference engines such as triplestore to explore unknown relations.

Lineage between persistent data or model entities are identified as parent and child relationships between two entities. Any persistent data or model is associated with mData stored in the processing mData database. The platform may automatically keep lineage at the data and model entity level that is uniquely identified by the mData identifier.

Lineage keeping and retrieval relies on the following set of relations inherit in graph model design, and keeping additional information in the processing:
1. Each graph including configuration is recorded and uniquely identified by graph instance id in the graph repo database
2. Each Processor instance may be uniquely identified by a processor instance id, and stored as part of the graph.
3. The input and output of processor instance is uniquely identified by a porti d, which consists of processor id, port number (an integer), and type (Input or output)
4. Each mData is associated with a port. Lineage represented as parent-child relationships is defined by the port relations from graph.
5. Graph encodes the port parent and child relationship between each port, which translates to parent and child relationship between mData

Basic and detailed lineage information is created by having the graph processing execution process automatically log the following information into, before (pre_processing) and after (post_processing) and main function call, and store them in a processing history database (metadata database) during the processing: mData_id, job_id, graph id, Processor instance id, processing id, and processing time.

Additional data that the Processor provides (e.g. content level information) either through custom pre-processing, post-processing or main function call addes finer level of lineages (e.g. at record and data value level).

To retrieve lineage information the recorded identifiers are linked to by graph id and along connector id that link port identifier to ascenstrial mData id. More specific steps are in the following.

First, information on graph job id, process_id, mData_id, port_id, creation timestamp associated with the graph execution may be recorded as structured data in the processing history metadata database.

The platform may auto generate and keep additional lineage information during processing by associating assigning a parent child relationship. Relationships may also be defined and each assigns a relation_id. Thus general lineage relation can be recorded as a triplets (mData_id_1, mData_id_2, relation_id), with mData_id1 being from each import port of the same processor; Additional relations, including custom relationship defined, and recorded in custom pre-processing step of processor execution.

Once such a relationship is recorded, all lineage information can be identified by combining the metadata information and graph topology defined as graph_id, and connection is identified by the two ports that it content to. This can be most easily done, for example by a graph query language. And new lineages discover by inference on the triple with a first order logic. For example the following steps may be followed to find lineage information is identified recursively after the data is recorded:
1) New mData of interest is identified by its mData_id. It is created by the associated processor and associated with the output port of the processor identified by processor_port_id (a port id is uniquely identified by processor instant id and port number and type).
2) Parents of mData_id and are recorded may be recorded in common pre-processing by associating mData_id with the mData ids from input ports_port_id; In addition, content level data association may be appended by processor customer processing.
3) Follow the graph topology to find the parent processors of the current processor. The mData ids from the input ports are to the output mData ids from the parent output ports. All the parent mData are associated if the parent is a root processor, otherwise, procedure in step 1 step followed to identify the relation triplet.

Additional information regarding the user, project, Processors, frameworks etc. can be associated in the process to give a complete picture of the lineage relationships for different purposes in production, model development, performance improvement, debugging, and others.

A completed graph, configuration of the graph and processors completed defines a graph job. Each job is identified by a job id. Such information completely defines the DataSet and other artifacts along the execution path, including lineage information from the last section.

Job_id, and using graph_id, and configuration information, along with processor library information (including driver and images configuration), provides complete specifications for reproducing DataSet and model content along the execution path. The result can be checkpointed, and in absence of the checkpoints, the process can be rerun with the speciation.

Thus, a graph job specification in essence constitutes an executable encoding/documentation of the entire application that can be stored as a structured data model, along with graph repository.

The information, when combined with the version of the Processors (i.e. defined by image version) and platform architecture configuration, together with the application and configuration completely defines the runtime behavior and data and models. Putting together, the above information renders the data and model, as well as runtime performance including processing time, resource (disk and memory), cpu/GPU usage, and other system metrics. This information may be logged and aggregated.

The log information may further be timestamped, and metadata information including data type, volume, can further be combined with processing time, cost, computing resource usage (cpu/gpu) through system monitoring. Models can be built to predict the resource usage and automate resource allocation including number of nodes, type of notes, computer architecture and size info including cpu/gpu types, memory, storage, and metrics.

Computing nodes in this specification and the following claims are also referred to interchangeably as computing devices, which can be used to implement the techniques described herein. For example, a portion or all of the operations described above may be executed by the computer device or nodes. Computing nodes in this specification is intended to represent various forms of digital computers, including, e.g., laptops, desktops, workstations, personal digital assistants, servers, blade servers, mainframes, and other appropriate computers. Computing device is intended to represent various forms of mobile devices, including, e.g., personal digital assistants, tablet computing nodes, cellular telephones, smartphones, and other similar computing nodes. The components shown here, their connections and relationships, and their functions, are meant to be examples only, and are not meant to limit implementations of the techniques described and/or claimed in this document.

Computing device includes processors, memory, storage device, high-speed interface connecting to memory and high-speed expansion ports, and low speed interface connecting to low speed bus and storage device. Each of the components are interconnected using various busses, and can be mounted on a common motherboard or in other manners as appropriate. Computer CPU/GPU/TPU etc. can process instructions for execution within computing devices, including instructions stored in memory or on storage devices to display graphical data for a GUI on an external input/output device, including, e.g., display coupled to high speed interface. In other implementations, multiple processors and/or multiple busses can be used, as appropriate, along with multiple memories and types of memory. Also, multiple computing nodes can be connected, with each device providing portions of the necessary operations (e.g., as a server bank, a group of blade servers, or a multi-processor system).

Memory stores data within computing devices. In one implementation, memory is a volatile memory unit or units. In another implementation, memory is a non-volatile memory unit or units. Memory also can be another form of computer-readable medium (e.g., a magnetic or optical disk. Memory may be non-transitory.)

Storage device computing nodes are capable of providing mass storage for computing devices. In one implementation, storage device computing nodes can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory computing nodes, storage device computing nodes, memory on processor, and the like.)

High-speed controller computing nodes manage bandwidth-intensive operations for computing devices, while low speed controller computing nodes manage lower bandwidth-intensive operations. Such allocation of functions is an example only. In one implementation, a high-speed controller is coupled to memory computing nodes, display computing nodes (e.g., through a graphics processor or accelerator), and to high-speed expansion ports computing nodes, which can accept various expansion cards (not shown). In the implementation, low-speed controller computing nodes are coupled to storage device computing nodes and low-speed expansion port computing nodes. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing devices can be implemented in a number of different forms. For example, it can be implemented as a standard server, or multiple times in a group of such servers. It also can be implemented as part of the rack server system. In addition or as an alternative, it can be implemented in a personal computer (e.g., laptop computer.) In some examples, components from computing device computing nodes can be combined with other components in a mobile device (not shown), e.g., device. Each of such devices can contain one or more computing device computing nodes, and an entire system can be made up of multiple computing nodes, communicating with each other.

Computing devices include computing processors, memory, an input/output device (e.g., display, communication interface, and transceiver) among other components. Devices also can be provided with a storage device, (e.g., a microdrive or other device) to provide additional storage. Each of the components are interconnected using various buses, and several of the components can be mounted on a common motherboard or in other manners as appropriate.

Computer processor can execute instructions within a computing device, including instructions stored in memory. The processor can be implemented as a chipset of chips that include separate and multiple analog and digital processors. The processor can provide, for example, for coordination of the other components of the device, e.g., control of user interfaces, applications run by device, and wireless communication by device.

Computer processor can communicate with a user through control interface, and display interface, coupled to display. Display can be, for example, a TFT LCD (Thin-Film-Transistor Liquid Crystal Display) or an OLED (Organic Light Emitting Diode) display, or other appropriate display technology. Display interface can comprise appropriate circuitry for driving display 1554 to present graphical and other data to a user. Control interface can receive commands from a user and convert them for submission to the processor. In addition, external interface can communicate with the processor, so as to enable near area communication of the device with other devices. External interfaces can provide, for example, for wired communication in some implementations, or for wireless communication in other implementations, and multiple interfaces also can be used.

Memory stores data within a computing device. Memory can be implemented as one or more of a computer-readable medium or media, a volatile memory unit or units, or a non-volatile memory unit or units. Expansion memory also can be provided and connected to the device through expansion interface, which can include, for example, a SIMM (Single In Line Memory Module) card interface. Such expansion memory can provide extra storage space for devices, or also can store applications or other data for devices. Specifically, expansion memory can include instructions to carry out or supplement the processes described above, and can include secure data also. Thus, for example, expansion memory can be provided as a security module for a device, and can be programmed with instructions that permit secure use of the device. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory, expansion memory, and/or memory on processor), which can be received, for example, over transceiver or external interface.

Devices can communicate wirelessly through a communication interface, which can include digital signal processing circuitry where necessary. Communication interface can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceivers. In addition, short-range communication can occur, e.g., using a Bluetooth®, WiFi, or other such transceiver (not shown). In addition, GPS (Global Positioning System) receiver module can provide additional navigation- and location-related wireless data to the device, which can be used as appropriate by applications running on the device. Sensors and modules such as cameras, microphones, compasses, accelerators (for orientation sensing), etc. may be included in the device.

Device also can communicate audibly using audio codec, which can receive spoken data from a user and convert it to usable digital data. Audio codec can likewise generate audible sound for a user, (e.g., through a speaker in a handset or device.) Such sound can include sound from voice telephone calls, can include recorded sound (e.g., voice messages, music files, and the like) and also can include sound generated by applications operating on devices.

Computing devices can be implemented in a number of different forms, as shown in the figure. For example, it can be implemented as a cellular telephone. It also can be implemented as part of a smartphone, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing system for developing, operating, and managing AI and data centric applications, comprising:
a. one or more computers and one or more storage devices storing instructions that are operable, when executed by the one or more computers, to cause the one or more computers to perform operations comprising:
calling functions or services involving a multitude of computing components for data processing, machine learning, and other functions;
operating on a plurality of data sources that can be accessed from said computing nodes,
b. a metadata means herein referred to as mdata for describing data sources, comprising at least of: an identifier, location of the data source, and schema or schema location of the data sources,
c. a processor means for providing common representation and computing model for interaction with any computing components and data sources, further comprising:
a set of attributes comprising a unique identifier, name, descriptions, optional alias for instances, optional tags for classification,
zero or a more ports for connecting to providing connection points of different processors and types including input and output,
a named operation for invoking main operations of unlying computing component,
optional common operations including pre-processing and post-processing, which may be invoked automatically as part of the main operations or others,
a means for associating input and output data and/or metadata with ports,
a configuration means specifying customization and usage including adaptation to driver means of underlining resources and operations for, logic configuration, logic execution options, runtime parameters, computing and storage preferences, and others,
d. a graph model means for representing applications, comprising:
an identifier, and optional name, descriptions, alias, and other attributes,
a plurality of processor means for specifying processing logic,
a connector means linking output ports of a one processor to the input ports of another processor, representing execution order of execution, data and/or workflow connections,
a means for connecting pairs of processors using connector means to specify processing flow as directed graph,
a means for specifying configuration parameters, data sources, runtime behavior, executing mode, computing resources usage, and others,
whereby application can be expressed as an instance of graphs comprising a set of chosen processors connected together according to said graph model, with connections indicating order of processor execution, direction of data flow, and behavior controlled by configuration parameters,
g. storage for the storing instances of graph specifications and configuration,
h. an execution engine means for executing said graph instances comprising:
a means for instantiating the graphic instances with configurations, and
a means for executing processor instances further comprising:
a means for instantiating processors,
a means for invoking the main and optional stand methods of
processos, which may invoke said using computing components, as local library, remote service call, or using said container manager to launch images of processing logic in one or more of said computing nodes,
a means to orchestrate to execution of processors based on configuration parameters including mode of execution including, such as batch, stream, mixture of the two, and workflow,
an optional means to for propatating metadata and input and output between ports,
an optional means of specifying conditions of processor execution,
i. a runtime means for hosting the execution engine means in one or more of the computing nodes,
j. an optional services means providing remote access to the execution engine from the user,
k. a propagation means for data and/or metadata items between any processor comprising associating: a means to associates items input ports, and with output port of out processor, and accessing it through connector which is connected to the port of next processor; and optionally using a common means of common data objects and shared storage,
l. An optional data object means for common data operations including access, read, write, update, transformation, and others,
m. a storage containing a library of processor driver specification,
n. a storage that stores metadata of the said data sources, storing at least a table with the location of the data sources, which could be a uri or other identifiers, and optionally schema of data or location of the schema,
whereby computing and data sources may be represented as a reusable processor, and processors connected as directed graphs represents application programs, with behavior fine controlled by configurations parameters; execution engines provides runtime environment and orchestration graph execution process involving variety of execution modes; a systematic means for representing, composing, and execution of applications involving heterogeneous components and data sources of any kind; different applications goals may be achieved by choosing different said component collections, providing a systematic way collaborate between components and teams, and ways to adapt to underlying components and computing resource changes.

2. The computing system of claim 1, wherein said processor further comprises
a. a driver configuration means for associating with an underlying computing component, comprising a selection of drivers, which may comprise:
an implementation of the function where the component is in local in runtime environment,
client calls to the component which is hosted remotely,
co-located with the component and executed remotely in a different node or in a container by processor
b. an executor means for executing the drivers,
c. A service means for providing services to the executor, and may further include data and metadata services, and parallelization services the helps binding data and metadata to the driver, enable running the part or all of the driver functions in parallel.

3. The computing system of claim 2, where the processors and graph further comprises a set of configurable parameters, and the application graphs are instances of processing flow and are further specified by a selection of the configuration parameters:
a. parameters required by the underlying processing components,
b. input and output data set using optionally using mdata,
c. runtime behavior control parameters,
d. any parameters to control application behavior, input and output behavior, required by processor, graph, computing and storage resources, and others

4. The computing system of claim 3, wherein the execution engine means further comprises:
a. a graph instantiation means proving operation to take runtime specification configuration as input, and
b. a means to perform functions to invoke operations specified in the application graph and processors.
c. a means to provide and selection of executors to process the application graph for batch, stream, or a combination thereof, or as task workflows.
d. optional additional apparatus including state machines for controlling and transition of runtime states, and mdata, and and various events generated during the graph execution,
e. optional service means to help dynamically launch processors and underlying components, schedule processing and meter processing flow, and orchestrate process flow among processors.

5. The computing system of claim 4, further comprises a apparatus for programming applications as graphs, comprising:
a. a storage for a library specification of said processors,
b. a means including web service or remote procedure calls for creating, reading, updating, and deleting elements of said graphs specified by said graph model,
c. a storage and storage for graph graph definition elements, comprising at least an identifier of graphs, optimally name and descriptions, and elements in said graph model and configurations,
d. [an optional command line utility that uses the said means of item b to carry out the operations for programming,
whereby applications are created, updated, and stored as graphs and configuration.

6. The computing system in claim 5, further include a graphical user interface for visually programming, operating, and monitoring the applications, comprising:
a. a display means for displaying the library of processors, which may further be organized in various structures, such as trees, lists and having a search function,
b. a display means with canvas providing CRUD through drag-and-drop and other actions conjunction with said library and the web services, with processors visually represented as icons and connections as lines,
c. a display means for visually configuring processors and connections
d. a means to visually configure graphs
e. an action means actions for associating user action with backend actions the system may further contain the following panels supporting one or more operations such as, creation, retrieval, view, update, delete, view, exploration for:
f. administration, user management, preferences management,
g. data and metadata,
h. projects,
i. security setting, including platform, data, and user roles,
It may further support operations including graph processing state and processor state.

7. The computing system of claim 5, further comprising shared storages for runtime state, mdata queue, dataset queue, and distributed data sources: wherein the application graph is executed on a distributed cluster of computing nodes, and the execution engine and processors hosted on one or more separate nodes referred to as masters; some or all the computing nodes for workers are in the public cloud, on-premises, and edge devices.

8. A computer-implemented method for providing data communication and sharing comprising computing programs (such as processors in the method of claim 1), in between one more nodes that are network connected, comprising:
a. providing one or more common storage which may use storage media various tiers,
b. providing a second common storage that are programmatically accessible to all the said computing components,
c. providing a dataset object comprising: (1) including a reference to store of data on one of the said storage media, such as distributed memory store, persistent volumes as in Kubernetes, databases, and others store that can be accessed from the network, (2) including a common interface definition for data query in interacting with the store, providing read and write of data values in the store; one such interface involve using (key, value) pairs, wherein key is a name assigned to the data and value is the data content in the store, another method involve using SQL or some other query mechanism that the store supports, (3) providing a set of operations in relation to the store and transformations on the data,
d. causing the program in the first computing node to creates a dataset object, including configuring a store, and optionally writing data to the store, and publishing it to the second common storage; causing the second program which may be on the same computing node or a different node to discover and accesses and uses the dataset object through the common interface, without needing to be visible to the underlying storage,
e. optionally performing operations on the object by invoking operational methods that provide various transformations on the data,
f. the said components may be the processors of the computing systems in the proceeding claims or other computing environments.
whereby data content is shared in a dataset object which may be embodied in the language a individual program uses to represent the common dataset object in a shared storage, avoiding copying, and all programs uses a common protocol implemented either through a standard language such as SQL, an object format, or web service, and access the same data content that resides in the shared media.

9. The computing system of claim 7, wherein the common data object means further comprises an apparatus for using dataset of method of claim 8 for data objects, thus proving a common data object for all processors.

10. A computer-implemented method for systematically composing, operating, and managing AI and data centric applications using various data processing, machine learning, and other computing components executed on computing nodes, comprising:
a. proving one or more computing nodes, including standard alone hardware computer with processing units, memory, storage, or in and across cloud environment; and selecting computing components for the application; providing access to data sources of various type
b. providing a processor means for interaction with the computing components and data sources, comprising:
providing a processor interface means including a unique identifier, optional name and descriptions, input and output ports for connecting with other processors that can be used for sending and receiving data;
proving a main function means for invoking functions of the computing components;
and optionally providing helper functions for preprocessing, post processing, and custom operations;
providing a driver means for programmatically invoking functions of underlying computing components and passing data and parameters,
c. providing a graph model means for representing applications comprising using using nodes to represent processors and edge to represent connection between ports, and nodes being the processors means and edge being connectors,
d. optionally providing a metadata means for representing and accessing data sources, of arbitrary types that are accessible on to the computing nodes, including at least location and schema or schema locations,
e. providing a processor runtime means for managing the processors life cycle and executing the processor in as part of graph,
f. proving a graph runtime means for managing graph life cycle and executing graphs, including creating, retrieving, updating, and deleting; orchestrating processing flow in various modes, including batch and stream dataflow, and workflow; and managing running state transitions, which may include start, pause, resume, and stop; and for monitoring execution of the graph in various modes.
g. optionally providing application programming means based on said graph model for composing applications,
h. providing configuration means of for specifying parameter of said processors and graphs in a unified way,
i. providing a storage for storing application represented as graphs and said configurations,
j. optionally providing visual programming means for visually programming and configuration applications, and GUI for other activities, including operations, monitoring, and management,
whereby any computing components and data sources can be represented and operated upon as part of an application through a processor, and the application can be composed in a standard way, and executed in the runtime on one or more nodes, while invoking components which may reside on the same other computing nodes; additional advantages including programming, data communication between processors and parallelization for all component are described in claims that follow.

11. The graph model in the method in claim 10 may further a means for nested representation and composition, comprising:
a. taking the entire graph as a computing component, and
b. representing subset of the processors of the graph as a processors, composing:
creating a new processor identifier,
adding an input ports to the processor for each input port of the first set of the processors of the parent graph; making a new ports for each starting processor representing data sources and optionally limiting data to the import to the source data type,
adding an output ports to the processor for each output port of the last group of the processors; and adding a new output ports for each end group of processors which represent data sinks and has zero output;
associating the main operator of the processor to command for executing the subgraph,
Translating configuration parameters and runtime mapped to the configuration parameters or runtime parameters,
c. optionally adding the new processor to processor library, and associating a visual type in the graphical user interface
d. treating the new processor as regular processor in new graph composition and execution

12. The processor in the method of claim 11, further comprise:
providing driver means comprising:
a. providing a interface to computing component in language that the components supports, such as python, java, C++, go, or others,
b. proving a commands line module for using the interface along with optional parameters,
c. making drive accessible with processor interface by providing the loading location (path),
d. optionally providing a container images including the underlying component and the driver,
associating the main operation with commands;
associating input and output data with input and outputs ports of the processors, respectively,
whereby computing components are made executable by designated processors, and can be used as part of graphs for applications.

13. In the processor runtime means of the method of claim 10, wherein the runtime means further comprising:
a. The proving a service means for remote interaction, including through web services that implement processor interface,
b. providing a means for launching processor driver, including running as a local library co-located on the server, interaction with computing components that are remote components, and launching different worker, which may be a separate computing node, container in a container environment such as pod in a virtual environment such as kubernetes;
and wherein the processor execution means further comprising:
initialing the processor by building a processor object, comprising assigning the configuration parameters and biding to the processor driver,
reading the input port data and metadata, setting the input data and metadata from the connector if the input port is connected to another processor,
execute pre-processing steps, including common and custom steps, and callback function,
execute the main function,
execute the post-processing methods

14. The graph runtime means in the method of claim 13, wherein the execution means further comprises:
a. providing a services means for remote interactions, including through web services,
b. providing management means that can be accessed through the service means for managing the graph lifecycle and and execution means, comprising:
i. retrieving a stored application graph and configurations from storage,
ii. Instantiating the graph in the memory as computing object in the computing nodes,
iii. choosing an execution engine based on configurations or use a default execution engine,
iv. start the the graph processing orchestration algorithm comprising choosing the first set of processors as workset, execute the processors in the workset, monitoring execution conditions and signals, and resent resetting the workset based if conditions are met or until the processor finishes processing, and loop through the entire set of the graph or until a state change signal is received.
v. for batch processes, stop the processing when last processor finishes execution, for stream processing, loop on incoming data streams until the stream is empty or terminating sign

15. parallel and distributed processing engine] The method of claim 14, further includes a means for providing configurable and automated parallel and distributed processing of commuting components, including selections of:
a. providing processors to redistribute and collection data based on various parameters (map-reduce, fork-join): (1) splitting the dataset based on keys into specified number of groups, and assign to each group a group key (2) providing the same number of as groups of processes on the same nodes or multiple nodes, either by multiple threads, multiple mods, using multiple nodes, multiple workers, or a mixture one computing nodes of the two, (3) map the associated data to the process groups, (4) group the output of processing with dataset with group key, (5) combine the output dataset into the the one dataset;
b. providing task or pipeline parallelization comprising (1) associating with each processor an scheduler (2) providing a processing metering mechanism by assigning configurable events that may depend on the processor state events including input or output data of connected processors (3) set processor runtime state based on the metering configuration;
c. providing task parallelization and distributed processing capabilities by using a third party task parallelization context with each processor, and associating the context to the processor driver which uses the context to manage parallelization, whereby adding data and task parallelization for the processing involgin underlying computing components.

16. The method of claim 15, further comprises a means for virtual deployment of the said application graph, comprising:
a. using a node manager to manage the set of computing nodes
b. pre-installing computing components on the nodes
c. dynamically the launch the components by launching workers dynamically
d. competing the rest of the processing

17. The lineage tracking means in the method of claim 16, further comprises:
a. modeling lineage various at dataset, record, and other data granularity levels by assigning a identifier to the entities
b. using one or more programmatic modules to log the invocation of data and their content and associating with the identifier,
c. optionally providing a method for processor drive to call to log linkage for custom output data,
d. associating each output data of the processor with the input that is used, logging custom linkages,
e. invoking the association modules before, during, and after the main method execution,
f. recording the linkages of output data to input data in the lineage tables.

18. The application programming means in the method of of claim 17 (claim 10), further comprises:
a. proving runtime services including, creating new graph elements, CRUD of processors, connections, and other elements,
b. Initiating a graph object implementing the graph model, including an identifier, name, optional descriptions, and other configuration parameters, and work iteratively:
adding one processor or more processors,
optionally configuring the ports of the processors, including specifying numbers and type of ports, specifying input and output data and metadata,
connecting one port of the first processor to the input port of the second processor,
c. providing a configuration means for specifying user options to control all aspect of application behavior,
d. optionally providing means for testing and validation of graph,

19. The method of claim 18, wherein the graph configuration further comprise:
a. associating computing component parameters with processors configuration parameters, main command line function or services methods to main method of processor, and runtime parameters to graph runtime parameters, in addition to application level runtime parameters; associating application runtime to execution engine,
b. associating processor logic implementation with execution drivers, which may be deployed as container images, which is further associated to workers, which are in turn associated and make configurable with computing nodes architecture types
c. associating workers the computing node architecture, memory, storage and other resource parameters,
d. having an execution engine dynamically parsing and assigning the associations, which can be implemented as rules or algorithmically that dynamically optimizes the assignment,
whereby complete application becomes systematically configurable at all level of gratuity and the architecture layers, including algorithms at computing component level, node architecture architecture, deployment architecture, computing resource usage, runtime behavior, level and methods of parallelization; thus providing hiding technical complexity and make technology components accessible to users of less skill levels.

20. The visual programming means of the method in claim 19, further comprises:
a. Providing a display means for displaying the library of processors, which may further be organized in various structures, such as trees, lists and having a search function,
b. providing a panel a display means and canvas for providing CRUD actions conjunction with said library and said grographhing runtime means,
c. associating the actions to said programming runtime means,
d. providing a display means for visually configuring processors and connections,
e. providing a display means for visually configuring graphs with parameters mapping to those of said configuration means,
f. providing an action bar to updo, redo, and save the visual actions,
g. providing toolbar for graph state control,
h. optionally further providing display means for data, metadata exploration, graph store, project and user management,
whereby creating graphs may comprises finding one or more processor from said library, dropping to the canvas, which renders a visual icon of the processor, which may further be custom labeled; connecting one output port of the one processor to the input port of the second processor by adding a connector; the task bar provides actions to interact with the graph, including additional configurations, validating configurations, and changing states.
